(19) United States
(12) Patent Application Publication
(10) Pub. No.: US 2026/0064515 A1
(43) Pub. Date: Mar. 5, 2026

(54) MANAGING IO TIMEOUT IN NON-VOLATILE STORAGE DEVICES

(71) Applicant: Kioxia Corporation, Tokyo (JP)

(72) Inventor: Jithendra Devegowda, San Jose, CA (US)

(73) Assignee: Kioxia Corporation, Tokyo (JP)

(21) Appl. No.: 18/821,153

(22) Filed: Aug. 30, 2024

(51) Int. Cl. G06F 11/07

(52) U.S. Cl. CPC G06F 11/079; G06F 11/0757; G06F 11/0772

(57) ABSTRACT

Various implementations described herein relate to a storage device including a non-volatile memory and a controller coupled to the non-volatile memory. The controller is configured to determine an input/output (IO) value, receive from a host a plurality of IO commands, each of the plurality of IO commands comprising reading data from the non-volatile memory or writing data to the non-volatile memory, determine that at least one IO command of the plurality of IO commands cannot be processed within a time period indicated by the IO timeout value, and provide a notification to the host that the at least one IO command of the plurality of IO commands cannot be processed within the time period indicated by the IO timeout value.

### TECHNICAL FIELD

The present disclosure relates generally to non-volatile memory devices, and in particular, to thin provisioning of non-volatile storage devices.

### BACKGROUND

A host can provide transfer data to and from a non-volatile storage device (such as a solid state drive (SSD)) via queues. For example, in the current non-volatile memory express (NVMe) specification, the host can transfer data via 64K IO queues, each of which has an IO queue depth of 64K. The host can check a maximum number of queues and a maximum queue depth supported by the non-volatile storage device. The host can submit IO commands to each supported queues up to the maximum queue depth. However, the non-volatile storage device may have limited throughput (e.g., bandwidth) to support data transfer rate to and from the host. In some cases, the host may submit a maximum number of IO commands (up to the maximum queue depth) on all queues, and the non-volatile storage device cannot process (e.g., complete or service) the commands within the timeout requirement of the host due to limited throughput of the non-volatile storage device. This can result in a timeout as the host considers that the non-volatile storage device has failed to respond, and the host can perform controller reset for the non-volatile storage device. This is because the host is unaware that the cause is that the host sending more IO commands than the non-volatile storage device can handle as per the throughput supported by the non-volatile storage device.

### SUMMARY

The arrangements described herein relate to a storage device including a non-volatile memory and a controller coupled to the non-volatile memory. The controller is configured to determine an input/output (IO) timeout value, receive from a host a plurality of IO commands, each of the plurality of IO commands comprising reading data from the non-volatile memory or writing data to the non-volatile memory, determine that at least one IO command of the plurality of IO commands cannot be processed within a time period indicated by the IO timeout value, and provide a notification to the host that the at least one IO command of the plurality of IO commands cannot be processed within the time period indicated by the IO timeout value.

The arrangements described herein relate to a method including determining, by a controller of a storage device, an IO timeout value, receiving, by the controller of the storage device, from a host a plurality of IO commands, each of the plurality of IO commands comprising reading data from a non-volatile memory or writing data to the non-volatile memory, determining, by the controller of the storage device, that at least one IO command of the plurality of IO commands cannot be processed within a time period indicated by the IO timeout value, and providing, by the controller of the storage device, a notification to the host that the at least one IO command of the plurality of IO commands cannot be processed within the time period indicated by the IO timeout value.

The arrangements described herein relate to a storage device including a non-volatile memory and a controller coupled to the non-volatile memory. The controller is configured to receive, from a host, an IO timeout value, receive, from the host, a command to provide a notification based at least in part on a throughput of the storage device and the IO timeout value, receive, from the host a plurality of IO commands, each of the plurality of IO commands comprising reading data from the non-volatile memory or writing data to the non-volatile memory, determine that at least one IO command of the plurality of IO commands cannot be processed within a time period based at least in part on the IO timeout value and the throughput, and provide, to the host, the notification to the host that the at least one IO command of the plurality of IO commands cannot be processed within the time period.

### BRIEF DESCRIPTION OF THE FIGURES

FIG. 1 shows a block diagram of a system including a non-volatile storage device AND a host according to some implementations.

FIG. 2 is a flowchart diagram illustrating an example method for managing IO timeout in a non-volatile storage device, according to various arrangements.

FIG. 3 is a table illustrating total data sizes of IO commands and throughputs of the storage device, according to various arrangements.

FIG. 4 is a flowchart diagram illustrating an example method for managing IO timeout in a non-volatile storage device, according to various arrangements.

### DETAILED DESCRIPTION

The arrangements disclosed herein relate to systems, methods, apparatuses, and non-transitory computer-readable media for managing IO timeouts, for example, by allowing the host to set an IO timeout value at a non-volatile storage device and requests that the non-volatile storage device provide a notification to the host in response to the non-volatile storage device determining that it cannot process some IO commands within a time period indicated by the IO timeout value. Rather than declaring a timeout at the host side, the host can slow down send the IO commands to the non-volatile storage device or update the IO timeout value to allow the non-volatile storage device a longer time period to respond to the IO commands. The arrangements of the present disclosure avoids unnecessary controller resets thus improving efficiency and power consumption in the overall IO performance of the non-volatile storage device.

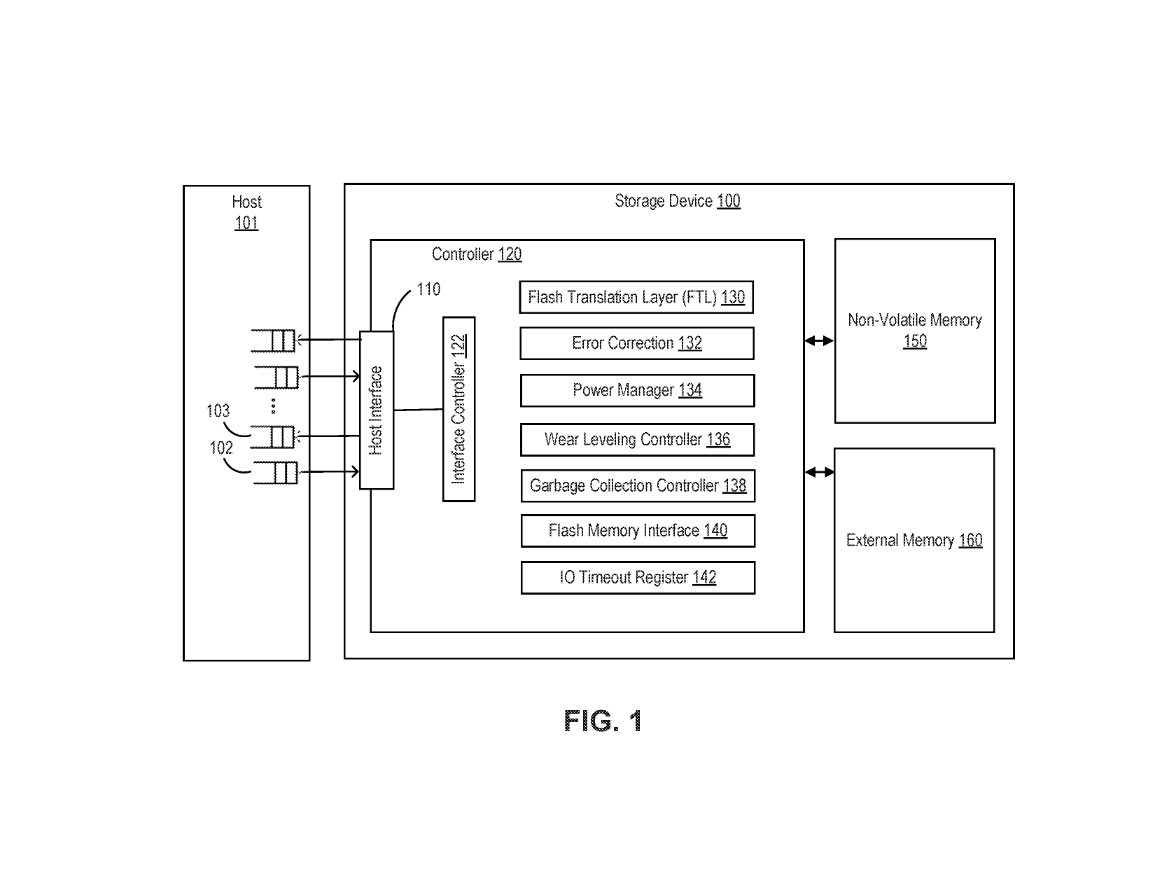

FIG. 1 shows a block diagram of an example system including a non-volatile storage device 100 (e.g., an SSD) coupled to a host 101, according to some implementations. Referring to FIG. 1, a system (e.g., computer system) can include the host 101 and the storage device 100. The storage device 100 can be a storage device and can be used as a main storage of an information processing apparatus of the host 101. The storage device 100 can be incorporated in the information processing apparatus or can be connected to the information processing apparatus via a cable or a network.

The host 101 (e.g., a computing device) can include a file system that accesses the storage device 100. The host 101 can be a server (storage server) that stores a large amount of various types of data in the storage device 100. In other examples, the host 101 can be a personal computer. The host 101 includes a file system configured to control file operation (e.g., creating, saving, updating, or deleting) in connection with data. Examples of the file system include zettabyte file system (ZFS), Btrfs, extended file system (XFS), ext 4, or new technology file system (NTFS). In some examples, the host 101 can include a file object system (e.g., Ceph Object Storage Daemon) or a key value store system (e.g., RocksDB) can be used as the file system.

In some examples, the host 101 can be a user device operated by a user. The host 101 can include an operating system (OS), which is configured to provide the file system and applications that use the information processing apparatus. The file system communicates with the storage device 100 (e.g., a controller 120 of the storage device 100) over a suitable wired or wireless communication link (e.g., a Peripheral Component Interconnect Express (PCIe) connection) or network to manage storage of data in the storage device 100.

In that regard, the file system of the host 101 sends data to and receives data from the storage device 100 (e.g., IO operations) using a suitable host interface 110 of the storage device 100. The host interface 110 allows the software (e.g., the information processing apparatus) of the host 101 to communicate with the storage device 100 (e.g., the controller 120). While the host interface 110 is conceptually shown as a block between the host 101 and the controller 120, the host interface 110 can include one or more controllers, one or more namespaces, ports, transport mechanisms, and connectivity thereof. To send and receive data, the software or the file system of the host 101 communicates with the storage device 100 using a storage data transfer protocol running on the host interface 110. Examples of the protocol include but are not limited to, the serial attached small computer system interface (SAS), serial at attachment (SATA), PCIe, and NVMe protocols. While the examples presented herein refer to the elements of the NVMe protocol, the mechanism for managing IO timeouts can be likewise implemented in other protocols. The host interface 110 includes hardware (e.g., controllers) implemented on the host 101, the storage device 100 (e.g., the controller 120), or another device operatively coupled to the host 101 and/or the storage device 100 via one or more suitable networks. The host interface 110 and the storage protocol running thereon also includes software and/or firmware executed on the hardware.

Some storage data transfer protocols (e.g., NVMe) can support one or more IO queues, such as submission queues (e.g., submission queue 102) and completion queues (e.g., completion queue 103) in a host 101. For example, the host 101 can write data (as a queue entry) to the submission queue 102 and trigger a doorbell register when commands are ready to execute. The controller 120 can then pick up the queue entries in the receiving order and/or in the order of priority. The controller 120 can indicate/post the status for completed commands (e.g., completed write commands) in the completion queue 103.

In some examples, the storage device 100 is located in a datacenter (not shown for brevity). The datacenter can include one or more platforms, each of which supports one or more storage devices (such as but not limited to, the storage device 100). In some arrangements, storage devices within a platform are connected to a Top of Rack (TOR) switch and can communicate with each other via the TOR switch or another suitable intra-platform communication mechanism. In some arrangements, at least one router may facilitate communications among the storage devices in different platforms, racks, or cabinets via a suitable networking fabric. Examples of the storage device 100 include non-volatile devices such as but are not limited to, an SSD, a Non-volatile dual in-line memory module (NVDIMM), a universal flash storage (UFS), a secure digital (SD) device, multi-function namespace device (MFND), and so on. In the example in which the storage device 100 includes an MFND which includes multiple controllers each of which is the controller 120, the arrangements described herein can be useful to maintain the throughput of each controller.

The storage device 100 can include a controller 120 (e.g., SoC controller), an internal memory (not shown) internal to the controller 120, and/or an external memory 160. The controller 120 includes suitable processing and memory capabilities for executing functions described herein, among other functions. The storage device 100 further includes a non-volatile memory 150 such as a NAND type flash memory or flash memory. In some arrangements, the external memory 160 can include a random access memory which is a volatile memory, for example, dynamic random access memory (DRAM). In some arrangements, the internal memory includes a random access memory such as static random access memory (SRAM).

The controller 120 can include processors, microcontrollers, central processing units (CPUs), caches, and/or buffers (e.g., buffers). The controller 120 includes, for example, a flash memory interface 140, and a DRAM interface, the host interface 110, all of which can be interconnected via a bus (not shown). The DRAM interface may function as a DRAM controller configured to control an access to the DRAM in the external memory 160. The flash memory interface 140 may function as a flash memory control circuit (e.g., NAND control circuit) configured to control the non-volatile memory 150 (e.g., NAND type flash memory) in reading and writing operations. The controller 120 can be configured to perform various processes by executing a control program (e.g., firmware) stored in, for example, a ROM (not shown). Examples of the controller 120 include but are not limited to, an SSD controller (e.g., a client SSD controller, a datacenter SSD controller, an enterprise SSD controller, and so on), a UFS controller, or an SD controller, and so on.

In some arrangements, the controller 120 can include a flash translation layer (FTL) 130 configured to execute data management and block management of the non-volatile memory 150. The FTL 130 can include a look-up table controller configured to translate logical addresses into physical addresses in the non-volatile memory 150. For example, data management can include management of mapping information indicating a correspondence relationship between a logical address (e.g., logical block address (LBA)) and a physical address of the non-volatile memory 150. In some arrangements, the look-up table controller can execute management of mapping between each LBA or each logical page address and each physical address using an address translation table (logical/physical address translation table).

The controller 120 can further include a garbage collection controller 138, a wear leveling controller 136, and a flash memory controller 132. The garbage collection controller 138 may execute garbage collection (GC) which is a process executed to generate a free block as a data write destination block. The wear leveling controller 136 may execute wear leveling which is a process of leveling the number of times of block erasure so that by preventing an occurrence of blocks with a larger number of erasures, the failure probability of the storage device 100 and the non-volatile memory 150 can be reduced.

In some arrangements, the non-volatile memory 150 can include a memory cell array which includes a plurality of flash memory blocks (e.g., NAND blocks). Each of the blocks may function as an erase unit. Each of the blocks includes a plurality of physical pages. In some arrangements, in the non-volatile memory 150, data reading and data writing are executed on a page basis, and data erasing is executed on a block basis. In some arrangements, the non-volatile memory 150 can include one or more of the NAND flash dies, which are non-volatile memory capable of retaining data without power. Each of the dies in the NAND memory cell array (e.g., NAND flash memory devices) may have one or more planes. Each plane has multiple blocks, and each block has multiple pages. The dies can be arranged in one or more memory communication channels connected to the controller 120. While the NVM or memory cell array 150 can be implemented as NAND dies, other examples of non-volatile memory technologies for implementing the non-volatile memory 150 include but are not limited to, magnetic random access memory (MRAM), phase change memory (PCM), ferro-electric RAM (FeRAM), resistive RAM (ReRAM), and so on.

The NAND memory cell array includes one or more individual NAND flash dies, which are non-volatile memory capable of retaining data without power. Thus, the NAND memory cell array refer to multiple NAND flash memory devices or dies within the non-volatile memory 150. Each of the NAND memory cell array includes one or more dies, each of which has one or more planes. Each plane has multiple blocks, and each block has multiple pages. In some arrangements, each NAND memory cell array is a three-dimensional NAND flash memory device which includes one or more blocks each having multiple layers.

The controller 120 can include an interface controller 122 configured to control the host interface 110. The interface controller 122 can function as a circuit which receives various requests from the host 101 and transmits responses to the requests to the host 101 via the host interface 110. The requests can include various commands such as an I/O command and a control command. The I/O command can include, for example, a write command, a read command, a trim command (unmap command), and a flush command. A command to write data (e.g., a host write data command) is called a “write command” at the host interface 110. The host write data is aggregated into the size required to form a program unit on the NAND does a program command result. The format command can be a command for unmapping the entire memory system (storage device 100).

In some arrangements, the garbage collection controller 138 can perform garbage collection by moving valid data from blocks that have some obsolete data, into different blocks (e.g., blocks with no valid data or empty blocks). Valid data refers to data that is currently in use and may not be removed from the non-volatile memory 150. Invalid data refers to data that is no longer of use and can be removed from the non-volatile memory 150.

The controller 120 further includes an error correction functionalities 132 that can correct errors in the data stored in the non-volatile memory 150. For example, the error correction functionalities 132 can implement a suitable Error Correction Coding (ECC) to correct such errors.

In some arrangements, the storage device 100 and the controller 120 includes a power interface includes any suitable interface (including pins, wires, connectors, transformers, and the like) that connects the storage device 100 to a primary (regular) power supply. The power interface is operatively coupled to the power manager 134. The power manager 134 is operatively coupled to a backup capacitor, the controller 120, the external memory 160, the non-volatile memory 150, and other components of the storage device100 not shown to provide power thereto. In some examples, a backup capacitor is used in response to the power interface or the power manager 134 detecting that the power from the primary power supply is interrupted. In that regard, the power interface or the power manager 134 includes suitable circuitry for detecting whether the primary power supply is interrupted and for the power manager 134 switching between primary power to backup power (e.g., from energy stored in the backup capacitor). The power interface includes a voltage regulator that regulates the voltage from the primary (e.g., the power interface) and backup power (i.e. backup capacitor) supplies to an operation voltage of the controller 120, the external memory 160, the non-volatile memory 150, and other components of the storage device100.

The backup capacitor (e.g., a power loss protection (PLP) capacitor, a backup power capacitor, and so on) can be a single capacitor or multiple capacitors arranged in banks or any other suitable configuration. The backup capacitor can be one or more supercapacitors, ultracapacitors, tantalum electrolytic capacitors, monolithic ceramic capacitors, aluminum electrolytic capacitors, or another type of capacitors capable of storing charges (backup power) and providing the backup power to the storage device 100. The backup capacitor is operatively coupled to the power manager 134 and in the event that the primary power from the power interface is interrupted (e.g., due to a system power loss or failure event), the power manager 134 receives power from the backup capacitor. During normal operation (e.g., when the power interface is receiving power via the host interface 110), the power manager 134 supplies power to the backup capacitor, keeping it in a charged state in readiness for any interruption or sudden loss of power from the host interface 110.

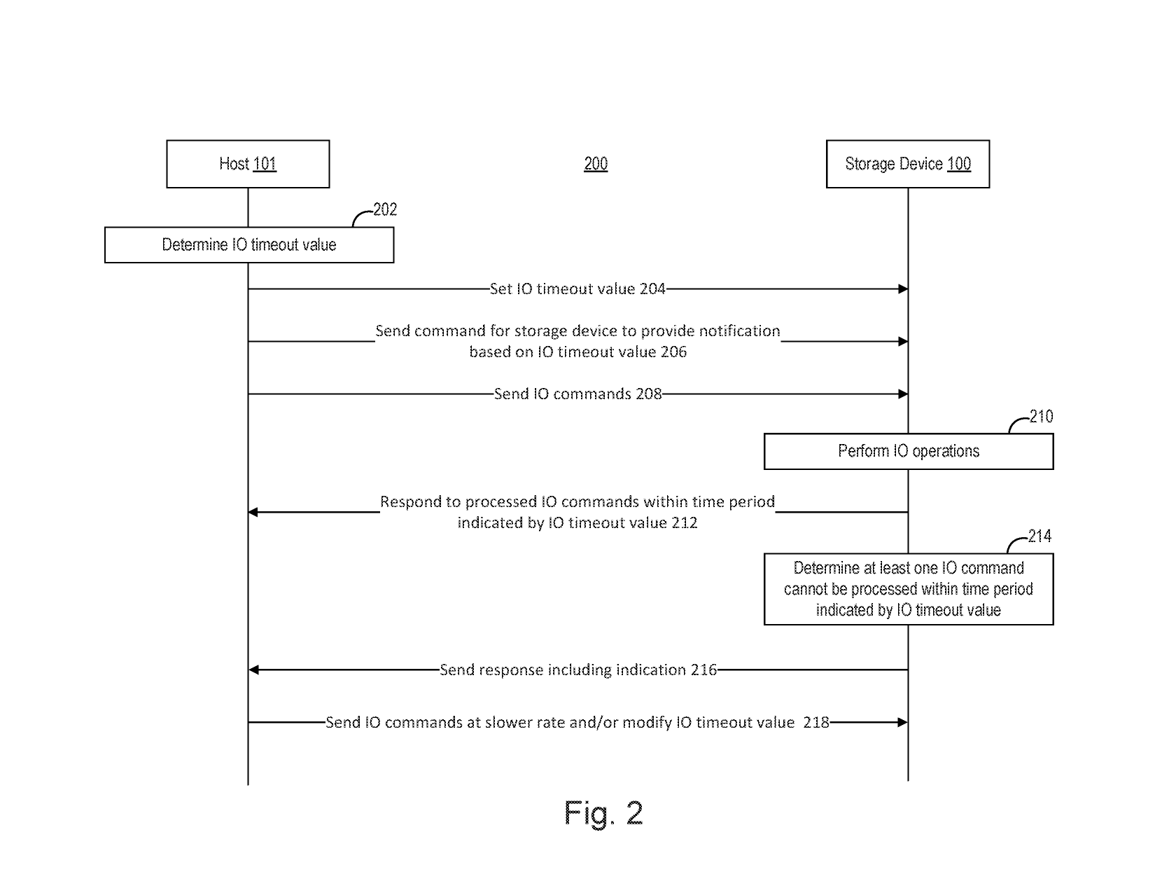

FIG. 2 is a flowchart diagram illustrating an example method 200 for managing IO timeout in a non-volatile storage device, according to various arrangements. The method 200 can be performed by the host 101 and the storage device 100 (e.g., the controller 120). At 202, the host 101 determines an IO timeout value. The IO timeout value can be an initial or default IO timeout value, and in other examples, the IO timeout value can be a value updated at 218 from a previous iteration of the method 200. Examples of the IO timeout value include 20 seconds, 30 seconds, 40 seconds, and so on.

At 204, the host 101 sets the IO timeout value to a register 142 of the storage device 100. For example, in the NVMe standard, the controller 120 can include various registers for storing various types of information. The host 101 can set the IO timeout value (e.g., a host IO timeout value) of an IO timeout register 142 of the controller 120 via the host interface 110. In some examples, the host 101 provides (e.g., sends) the IO timeout value to the controller 120, and the controller 120 receives the IO timeout value from the host 101.

At 206, the host 101 sends a command (e.g., an asynchronous event request (AER) command) to the storage device 100 (e.g., the controller 120) to provide a notification (e.g., asynchronous event notification (AEN) based at least in part on a throughput of the storage device 100 and the IO timeout value. The storage device 100 (e.g., the controller 120) receives the command via the host interface 110.

At 208, the host 101 sends IO commands to the storage device 100, and the storage device 100 receives the IO commands, via the host interface 110. The IO commands can be provided via queues (e.g., the submission queue 102). Each IO command includes reading data from the non-volatile memory or writing data to the non-volatile memory. At 210, in response to receiving the IO commands, the controller 120 performs IO operations (e.g., reading data, writing data, etc.) according to the IO commands or processes the IO commands.

The controller 120 can successfully process (e.g., complete, service, etc.) a portion of the IO commands, and at 212, the controller 120 responds to the host 101 via the host interface 110 for processed (e.g., completed, serviced, etc.) IO commands within the time period indicated by the IO timeout value 212. For example, the controller 120 can indicate/post the status for completed IO commands (e.g., completed write commands) in the completion queue 103.

In response to receiving IO commands, the controller 120 determines or predicts whether at least one IO command of the IO commands cannot be processed within a time period indicated by or based at least in part on the IO timeout value and the throughput of the storage device 100 at 214. In some examples, the IO timeout value is a length of the time period, and the time period starts from a time by which the IO command is sent or submitted by the host 101. In some examples, the length of the time period starts when the host 101 sends the IO commands given that for various reasons, the controller 120 may delay fetching the I/O commands (the host 101 does not consider the delay).

The throughput of the storage device 100 is the rate by which the storage device 100 can process IO commands and can depend on a variety of factors such as the manufacturer and model of the storage device 100, the structure of the non-volatile memory 150, the standard and protocol executable by the controller 120, the processing speed of various components of the controller 120, the processing speed of the host interface 110, the error correction scheme implemented by the error correction functionalities 132, the garbage collection scheme and the frequency by which it is run by the garbage collection controller 138, the wear and tear of the storage device 100 (e.g., the non-volatile memory 150), whether there are power interruptions, and so on. In some examples, the throughput of the storage device 100 is a predetermined parameter (e.g., in MB/s), which can be obtained through offline testing. In some examples, the predetermined parameter is made available to the storage device 100 in its internal device properties at the time of manufacturing so that the controller 120 can use this value determine the possible timeout as described. In other examples, the throughput of the storage device 100 can be dynamically determined by the controller 120 using a function with inputs such as one or more of the predetermined parameter, a length of time that the storage device 100 has been deployed or in-use, a rate of error correction, a rate of garbage collection, a number of bad blocks, etc. In some examples, the current throughput needs are determined to compare against the throughput that the storage device 100 supports. The current throughput can be determined by the controller 120 by monitoring the ongoing IO commands, the IO block sizes, the IO queue depth, the number of active queues, and so on, as described.

As described herein, the throughput is determined by the monitoring the ongoing IO commands, the IO block sizes, the IO queue depth, the number of active queues, etc.. The total data size of the at least one command can be determined based at least in part on one or more of a number of active queues (e.g., the submission queues 102), a queue depth of each of the active queues, or block size in the active queues. In other words, the controller 120 determines the total data size of the at least one command based at least in part on at least one queue parameter.

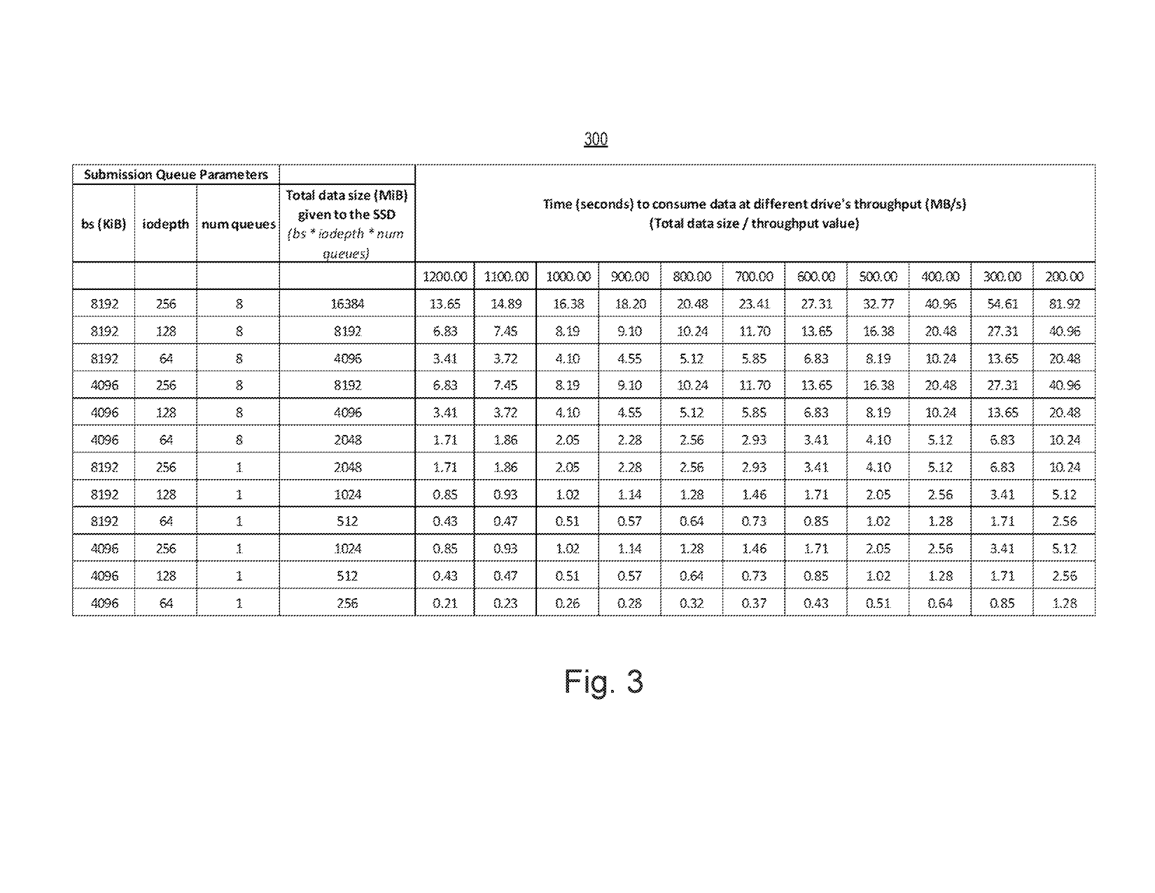

FIG. 3 is a table 300 illustrating total data sizes of IO commands and throughputs of the storage device, according to various arrangements. For example, the interface controller 122 of the controller 120 can obtain the submission queue parameters of the queues 102 via the host interface 110. The queue parameters include a number of active queues, a depth of each queue, and a block size for each queue. The total data size for various IO commands can be calculated by multiplying the number of active queues by the depth of each queue by the block size for each queue. For various throughputs of the storage device 100, the processing time needed to process the at least one IO command can be determined by dividing the total data size by the throughput. Assuming that the IO timeout value is set to be 30s, a predicted processing time greater than 30s would result in the determination that the at least one IO command cannot be processed within the time period indicated by the IO timeout value.

In other examples, the controller 120 determines or predicts that the at least one IO command cannot be processed within the time period based at least in part on one or more of a number of logical addresses (across all entries in the submission queues) or a data size of each of the logical addresses. By adding the data sizes of all logical addresses across all entries in the submission queues corresponding to the at least one IO command, a total data size of the logical addresses can be obtained. Similar to the table 300, for various throughputs of the storage device 100, the processing time needed to process the at least one IO command can be determined or predicted by dividing the total data size by the throughput. Assuming that time remaining until the end of the time period as indicated by the IO timeout value is 30 seconds, a predicted processing time greater than 30s would result in the determination that the at least one IO command cannot be processed within the time period indicated by the IO timeout value.

In some examples, the controller 120 determines or predicts that the at least one IO command cannot be processed within the time period based at least in part on detected drive failure of the storage device or loss of power. For example, the controller 120 can determine a drive failure when the number of bad blocks is greater than a predetermined threshold. The power manager 134 can determine a loss of power event. Drive failure and loss of power may result in failure to process the at least one IO command. Thus, upon detecting a drive failure or a loss of power, the controller 120 sends the notification to the host 101.

In some examples, the controller 120 determines or predicts that the at least one IO command cannot be processed within the time period based at least in part on a number of errors to correct by error correction of the controller. For example, the controller 120 can determine that the number of errors to correct or predicted to correct is greater than a predetermined threshold, and in response, the controller 120 sends the notification to the host 101.

In response to determining that the at least one IO command cannot be processed within the time period, at 216, the controller 120 sends a notification or response (e.g., a asynchronous event notification (AEN)) to the host 101 indicating that the at least one IO command of the plurality of IO commands cannot be processed within the time period. In some examples, the notification or response identifies the at least one IO command and/or a number of the at least one IO command that cannot be processed within the time period. At 218, the host 101, in response to receiving the notification, can slow down the rate by which the IO commands are sent to the storage device 100 and/or modify the IO timeout value 202. The new IO timeout value can be sent to the controller 120 similar to 204.

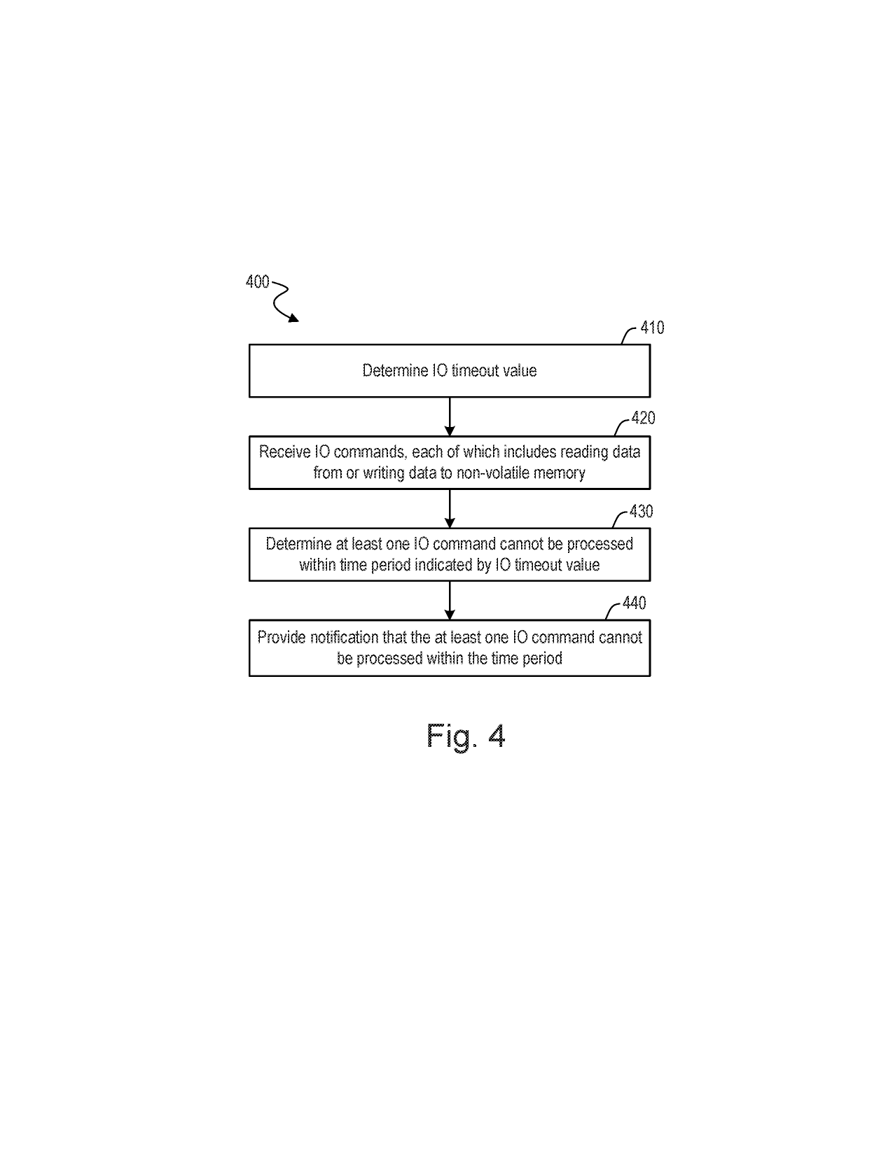

FIG. 4 is a flowchart diagram illustrating an example method 400 for managing IO timeout in a non-volatile storage device, according to various arrangements. The method 400 can be performed by the storage device 100 (e.g., the controller 120). The method 200 is a specific implementation of the method 400. At 410, the controller 120 determines an IO timeout value. Determining the IO timeout value includes receiving the IO timeout value from the host or setting a predetermined value as the IO timeout value. In addition to the host 101 maintaining a predetermined or default value, the controller 120 can also maintain a predetermined or default value that is the same as that of the host 101, thus the host 101 may not need to provide the IO timeout value initially. The host 101 can set the IO timeout value to an NVMe register 142 of the controller 120.

In some examples, the controller 120 is configured to receive a command (e.g., the AER) from the host 101 to provide the notification (e.g., the AEN). The notification is to be provided in response to determining that the at least one IO command of the plurality of IO commands cannot be processed within the time period indicated by the IO timeout value. In some examples, the command is received before processing or receiving the plurality of IO commands by the controller 120. In other examples, the command is received after at least some of the plurality of IO commands are received or processed.

At 420, the controller 120 receives from the host a plurality of IO commands, each of the plurality of IO commands includes reading data from the non-volatile memory 150 or writing data to the non-volatile memory 150.

At 430, the controller 120 determines or predicts that at least one IO command of the plurality of IO commands cannot be processed within a time period indicated by the IO timeout value. In some examples, the controller 120 determines or predicts that the at least one IO command of the plurality of IO commands cannot be processed within the time period based in least in part on a total data size of the at least one command and a throughput of the storage device 110. In some examples, the controller 120 determines the total data size of the at least one command based at least in part on one or more of a number of active queues, a queue depth of each of the active queues, or block size. In some examples, the controller 120 determines the total data size of the at least one command based at least in part on at least one queue parameter. In some examples, the controller 120 determines the total data size of the at least one command based at least in part on one or more of a number of logical addresses or a size of each of the logical addresses.

In some examples, the controller 120 determines or predicts that the at least one IO command cannot be processed within the time period based at least in part on detected drive failure of the storage device or loss of power. In some examples, the controller 120 determines or predicts that the at least one IO command cannot be processed within the time period based at least in part on a number of errors to correct by error correction of the controller.

At 440, the controller 120 provides a notification (e.g., AEN) to the host that the at least one IO command of the plurality of IO commands cannot be processed within the time period indicated by the IO timeout value.

In some examples, the controller 120 is configured to process a first portion of the plurality of IO commands and after processing the first portion of the plurality of IO commands, to determine that the at least one IO command of the plurality of IO commands cannot be processed within the time period. In some examples, the notification is provided after processing the first portion of the plurality of IO commands. In some examples, the notification is provided before processing the at least one IO command of the plurality of IO commands. In some examples, the notification is provided while processing the at least one IO command of the plurality of IO commands.

In some examples, in response to receiving the notification, the host 101 provides to the storage device 100 additional IO commands at a rate slower than a rate by which the plurality of IO commands or the at least one IO command is provided. In some examples, in response to receiving the notification, the host 101 provides an updated IO timeout value to the storage device 100.

The previous description is provided to enable any person skilled in the art to practice the various aspects described herein. Various modifications to these aspects will be readily apparent to those skilled in the art, and the generic principles disclosed herein can be applied to other aspects. Thus, the claims are not intended to be limited to the aspects shown herein, but is to be accorded the full scope consistent with the language claims, wherein reference to an element in the singular is not intended to mean "one and only one" unless specifically so stated, but rather "one or more.” Unless specifically stated otherwise, the term "some" refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase "means for."

It is understood that the specific order or hierarchy of steps in the processes disclosed is an example of illustrative approaches. Based upon design preferences, it is understood that the specific order or hierarchy of steps in the processes can be rearranged while remaining within the scope of the previous description. The accompanying method claims present elements of the various steps in a sample order, and are not meant to be limited to the specific order or hierarchy presented.

The various examples illustrated and described are provided merely as examples to illustrate various features of the claims. However, features shown and described with respect to any given example are not necessarily limited to the associated example and can be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein can be implemented or performed with a general purpose processor, a DSP, an ASIC, an FPGA or other programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods can be performed by circuitry that is specific to a given function.

In some exemplary examples, the functions described can be implemented in hardware, software, firmware, or any combination thereof. If implemented in software, the functions can be stored as one or more instructions or code on a non-transitory computer-readable storage medium or non-transitory processor-readable storage medium. The steps of a method or algorithm disclosed herein can be embodied in a processor-executable software module which may reside on a non-transitory computer-readable or processor-readable storage medium. Non-transitory computer-readable or processor-readable storage media can be any storage media that can be accessed by a computer or a processor. By way of example but not limitation, such non-transitory computer-readable or processor-readable storage media can include RAM, ROM, EEPROM, FLASH memory, CD-ROM or other optical disk storage, magnetic disk storage or other magnetic storages, or any other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which can be incorporated into a computer program product.

The preceding description of the disclosed examples is provided to enable any person skilled in the art to make or use the present disclosure. Various modifications to these examples will be readily apparent to those skilled in the art, and the generic principles disclosed herein can be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A storage device, comprising:
a non-volatile memory; and
a controller coupled to the non-volatile memory, wherein the controller is configured to:
determine an input/output (IO) timeout value;
receive from a host a plurality of IO commands, each of the plurality of IO commands comprising reading data from the non-volatile memory or writing data to the non-volatile memory;
determine that at least one IO command of the plurality of IO commands cannot be processed within a time period indicated by the IO timeout value; and
provide a notification to the host that the at least one IO command of the plurality of IO commands cannot be processed within the time period indicated by the IO timeout value.

2. The storage device of claim 1, wherein determining the IO timeout value comprises:
receiving the IO timeout value from the host; or
setting a predetermined value as the IO timeout value.

3. The storage device of claim 1, wherein the host sets the IO timeout value to a register of the controller.

4. The storage device of claim 1, wherein the controller is configured to receive a command from the host to provide the notification, the notification is to be provided in response to determining that the at least one IO command of the plurality of IO commands cannot be processed within the time period indicated by the IO timeout value.

5. The storage device of claim 4, wherein the command is received before processing the plurality of IO commands.

6. The storage device of claim 1, wherein the controller is configured to:
process a first portion of the plurality of IO commands;
after processing the first portion of the plurality of IO commands, determine that the at least one IO command of the plurality of IO commands cannot be processed within the time period.

7. The storage device of claim 6, wherein
the notification is provided after processing the first portion of the plurality of IO commands;
the notification is provided before processing the at least one IO command of the plurality of IO commands; or
the notification is provided while processing the at least one IO command of the plurality of IO commands.

8. The storage device of claim 1, wherein the controller determines that the at least one IO command of the plurality of IO commands cannot be processed within the time period based in least in part on a total data size of the at least one command and a throughput of the storage device.

9. The storage device of claim 8, wherein
the controller determines the total data size of the at least one command based at least in part on one or more of a number of active queues, a queue depth of each of the active queues, or block size;
the controller determines the total data size of the at least one command based at least in part on at least one queue parameter.; or
the controller determines the total data size of the at least one command based at least in part on one or more of a number of logical addresses or a size of each of the logical addresses.

10. The storage device of claim 1, wherein
the controller determines that the at least one IO command cannot be processed within the time period based at least in part on detected drive failure of the storage device or loss of power; or
the controller determines that the at least one IO command cannot be processed within the time period based at least in part on a number of errors to correct by error correction of the controller.

11. The storage device of claim 1, wherein in response to receiving the notification, the host provides to the storage device additional IO commands at a rate slower than a rate by which the plurality of IO commands or the at least one IO command is provided.

12. The storage device of claim 1, wherein in response to receiving the notification, the host provides an updated IO timeout value to the storage device.

13. A method, comprising:
determining, by a controller of a storage device, an input/output (IO) timeout value;
receiving, by the controller of the storage device, from a host a plurality of IO commands, each of the plurality of IO commands comprising reading data from a non-volatile memory or writing data to the non-volatile memory;
determining, by the controller of the storage device, that at least one IO command of the plurality of IO commands cannot be processed within a time period indicated by the IO timeout value; and
providing, by the controller of the storage device, a notification to the host that the at least one IO command of the plurality of IO commands cannot be processed within the time period indicated by the IO timeout value.

14. The method of claim 13, determining the IO timeout value comprises:
receiving the IO timeout value from the host; or
setting a predetermined value as the IO timeout value.

15. The method of claim 13, further comprising receiving a command from the host to provide the notification, wherein the notification is to be provided in response to determining that the at least one IO command of the plurality of IO commands cannot be processed within the time period indicated by the IO timeout value.

16. The method of claim 13, further comprising:
processing a first portion of the plurality of IO commands;
after processing the first portion of the plurality of IO commands, determining that the at least one IO command of the plurality of IO commands cannot be processed within the time period.

17. The method of claim 13, further comprising determining that the at least one IO command of the plurality of IO commands cannot be processed within the time period based in least in part on a total data size of the at least one command and a throughput of the storage device.

18. A storage device, comprising:
a non-volatile memory; and
a controller coupled to the non-volatile memory, wherein the controller is configured to:
receive, from a host, an input/output (IO) timeout value;
receive, from the host, a command to provide a notification based at least in part on a throughput of the storage device and the IO timeout value;
receive, from the host a plurality of IO commands, each of the plurality of IO commands comprising reading data from the non-volatile memory or writing data to the non-volatile memory;
determine that at least one IO command of the plurality of IO commands cannot be processed within a time period based at least in part on the IO timeout value and the throughput; and
provide, to the host, the notification to the host that the at least one IO command of the plurality of IO commands cannot be processed within the time period.

19. The storage device of claim 18, wherein
the command to provide the notification comprises an asynchronous event request (AER) command; and
the notification comprises an asynchronous event notification (AEN).

20. The storage device of claim 18, wherein the host sets the IO timeout value to a non-volatile memory express (NVMe) register of the controller.
